(19) United States
(12) Patent Application Publication
(10) Pub. No.: US 2019/0093418 A1
(43) Pub. Date: Mar. 28, 2019

(54) Protect a track

(71) Applicant: Rodney Kim Ferris, Neples, FL (US)

(72) Inventor: Rodney Kim Ferris, Neples, FL (US)

(21) Appl. No.: 16/350,498

(22) Filed: Nov. 23, 2018

Related U.S. Application Data
(63) Continuation-in-part of application No. 15/224,761, filed on Aug. 1, 2016, now Pat. No. 10,167,643.

(51) Int. Cl. E06B 1/70; E05D 15/06

(52) U.S. Cl. CPC E06B 1/70; E05Y 2900/132; E05D 15/0686

(57) ABSTRACT

Protect A Track is a protector unit for a sliding glass door sill plate which includes a sill riser cover and a sill plate cover which when locked in the field forms a unitary rigid unit to protect the sill plate and sill riser during construction allowing a sliding glass door to operate normally while in place.

### CROSS REFERENCE TO RELATED APPLICATIONS

This application is a Continuation-in-Part of U.S. Ser. No. 15/224,761 filed on Aug. 1, 2016 and published application 2018/0030747 published on Feb. 1, 2018.

### STATEMENT REGARDING FEDERALLY SPONSORED RESEARCH OR DEVELOPMENT

Not applicable

### NAMES OF THE PARTIES TO JOINT RESEARCH AGREEMENT

Not applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable

### STATEMENT REGARDING PRIOR DISCLOSURES BY THE INVENTOR OR A JOINT INVENTOR

Not applicable

### SEQUENCE LISTING

Not applicable

### BACKGROUND OF THE INVENTION

### Field of the Invention

The present invention relates to a protective cover unit for sliding door frame used in commercial and residential entryways to be used during construction or renovation.

### Background

Entryways in commercial and residential buildings serve several important purposes in their role as a transition from the exterior to the interior of the building. The primary goal of an entryway is to allow for ingress and egress while insulating the interior from the exterior. Entryways are intended to prevent intrusion of rainwater, the passage of air, transfer of heat and can enhance the appearance of the building. Once the building is “under roof” the windows and doors are installed in order to protect the interior thereof from the environment. This leaves the sliding door frame exposed to any damage from workers that remains within the building. Heavy traffic of workers entering the building, including the movement of equipment and materials, can often lead to severe damage to the sliding door frame.

Protective covers have been disclosed that are designed to temporarily remain on the sliding door frame during construction. Some have hinges which fasten to the door frame, others are blankets which cover the frame and others are metallic rigid ramps which overlie the door frame. The present invention provides a unique protector unit for the sliding door frame because of its two piece construction with means for rigidly connecting them together on the job site allowing a sliding door to operate normally while in place which is an improvement in the prior art.

### SUMMARY OF THE INVENTION

The following presents a simplified summary of the invention in order to provide a basic understanding of the many aspects of the invention.

The present invention is concerned with protecting the frame of a sliding door during construction.

The primary object of the present invention is to provide a two piece protector for the base frame of the sliding door frame.

A further object of the present invention is to provide an inverted U-shaped element which is capable of covering the sill riser.

A further object of the present invention is to provide a flat flexible sill plate cover with sufficient width and length to cover the sill plate.

A further object of the invention is to provide means for connecting the sill riser cover with the sill plate cover to create a rigid unitary protector unit.

A further object of the present invention is to provide scoring marks on the sill riser cover.

A further object of the present invention is to provide a plurality of channel members protruding from the lower surface of the sill plate cover to give stability thereto.

A further object of the present invention is to provide an additional segment to abut edge to edge with the sill plate cover to give additional depth.

Another object of the present invention is to provide a protector for the sliding door frame having a vertical jamb component.

Another object of the present invention is to provide a protector for the sliding door edge.

Another object of the present invention is to provide a protector having a locking means for securing the sill riser cover to the sill plate cover.

Another object of the present invention is to provide a protector unit for a two, three or four track sill plate.

These and other aspects of the present invention will become more apparent to those having ordinary skill in the art after reading the following description of the preferred embodiments of the present invention, when considered in conjunction with the accompanying formal drawings wherein the same reference numerals are used consistently throughout the many drawing figures. It should be understood that variations may be made in details and general features of the design without departing from the spirit and scope of the invention. In addition it is pointed out that the sill plate cover of the present invention is dimensioned such that it could be used to protect the vertical door jamb because the structure of the jamb would be similar as the sill plate. It could easily be screwed into the jamb and provide protection thereof. Likewise the sill riser cover could also be used to cover the edge of the sliding door.

### BRIEF DESCRIPTION OF THE DRAWINGS

FIG. 1 is an exploded view of sliding door frame with the protector unit of the present invention.

FIG. 2 is a detailed view of the connection means of the present invention.

FIG. 3 is a detailed view of another embodiment of the connection means.

FIG. 4 is a detailed view of still another embodiment of the connection means.

FIG. 5 is a detailed view of an additional segment connected to the sill plate cover.

FIG. 6 is a detailed view of another embodiment of the present invention known as Protect A Track.

FIG. 7 is a detailed view of the present invention showing use in a three track sliding door system.

FIG. 8 is a detailed view of the Protect A Track set up for up to four roller tracks.

### DETAILED DESCRIPTION OF THE DRAWINGS

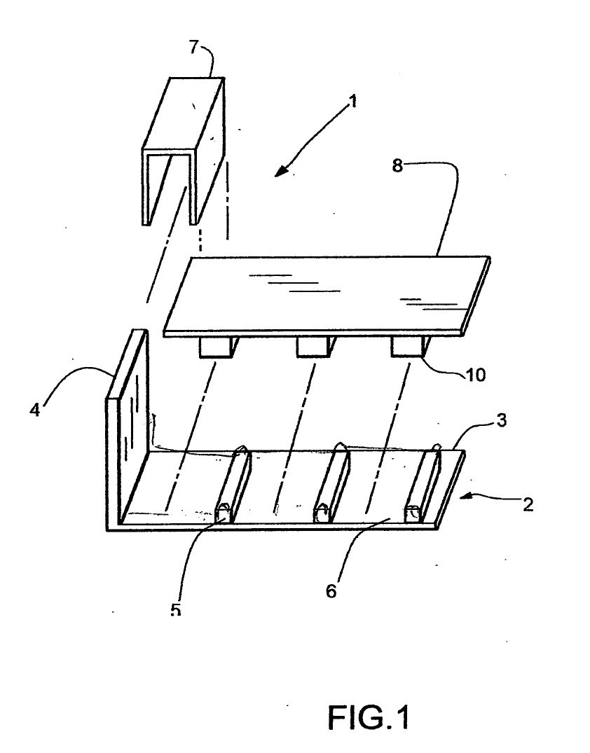

FIG. 1 is a detailed exploded view of the preferred embodiment of the present invention which includes a protector unit 1 for a sliding door frame 2. The sliding door frame 2 consists of a sill plate 3 and a sill riser 4. The sill plate 3 is attached to the door entryway and has a plurality of tracks 5 for supporting the rollers at the base of the sliding doors. The number of tracks 5 would be equal to the number of sliding doors plus screen doors for a particular building arrangement. A channel space 6 is provided on either side of the tracks 5 for passage of the sliding doors. For example, if there were three sliding doors then there would be three tracks and four channel spaces. This is well known in the construction trades and is not considered part of the present invention. The sill riser 4 abuts the sill plate 3 and extends parallel thereto. The height of the sill riser 4 is driven by the design pressure measured in pounds per square foot of wind pressure on the sliding door assembly. During construction of a building, the sliding door frame 2 is installed between the supporting walls of a building. The sliding door frame 2 is exposed to damage by the mere moving of equipment in and out of the building through the entryway. The protector unit 1 of the present invention provides for a sill riser cover 7 and a sill plate cover 8 which are fastened together by connection means 9. The sill riser cover 7 is shown as an modified inverted U-shaped flexible member made of a rubberized plastic, cardboard or vinyl material which can be either molded or extruded and can be up to ¼ of an inch thick. The sill plate cover 8 is flat planar flexible member having an upper surface 8a and a lower surface 8b which extends horizontally over the sill plate 3 and can be made of a rubberized plastic, cardboard or vinyl material which can be either molded or extruded and can be up to ¼ of an inch thick. A plurality of channel members 10 extend from said lower surface 8b of the sill plate cover 8 and are seated within the channel spaces 6 between the tracks 5 which give stability to the sill plate cover 8.

FIG. 2 is a sectional view of the connection means 9 showing the detail of the sill riser cover 7 having a first leg 7a and a second leg 7b with the first leg 7a having an extension edge 12 capable of mating with a slot 13 on the upper surface 8a of the sill plate cover 8. The extension edge 12 has a plurality of splines 14 positioned thereon to insure a rigid snap fit into the slot 13. The second leg 7b has a plurality of score marks 11a and 11b positioned vertically thereon which can be easily cut when the carpet pad, carpet, wood flooring are laid. For example, once the carpet and carpet pad were installed, the sill riser cover 7 would be cut at score mark 11a. If wood flooring was laid then the sill riser cover 7 would be cut at score mark 11b.

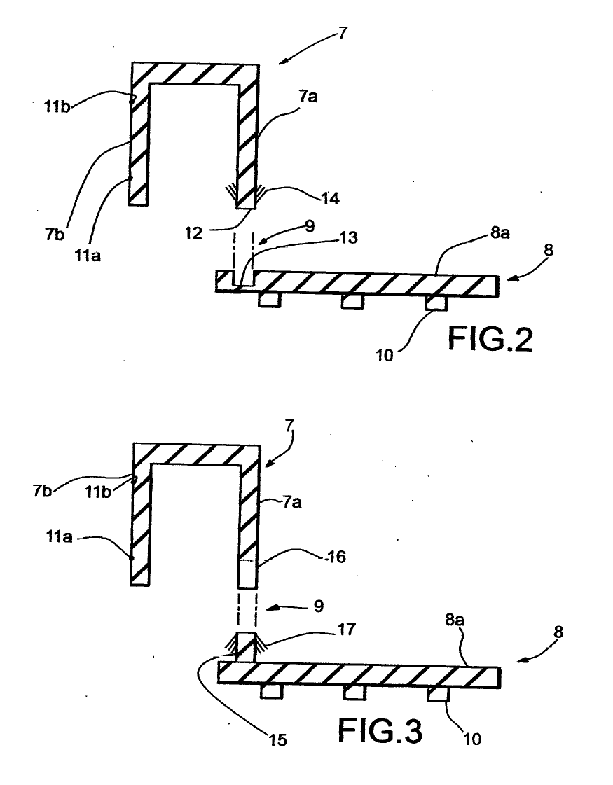

FIG. 3 is a sectional view of the connection means 9 showing the detail of the sill riser cover 7 having a first leg 7a and a second leg 7b and wherein the first leg 7a having a recess 16 which can easily mate with a finger 15 extending upwardly from the upper surface 8a of sill plate cover 8. The finger 15 can have a plurality of splines 17 thereon to insure a rigid snap fit into the recess 16 within the sill riser cover 7. For example, once the carpet and carpet pad were installed, the sill riser cover 7 would be cut at score mark 11a. If wood flooring was laid then the sill riser cover 7 would be cut at score mark 11b.

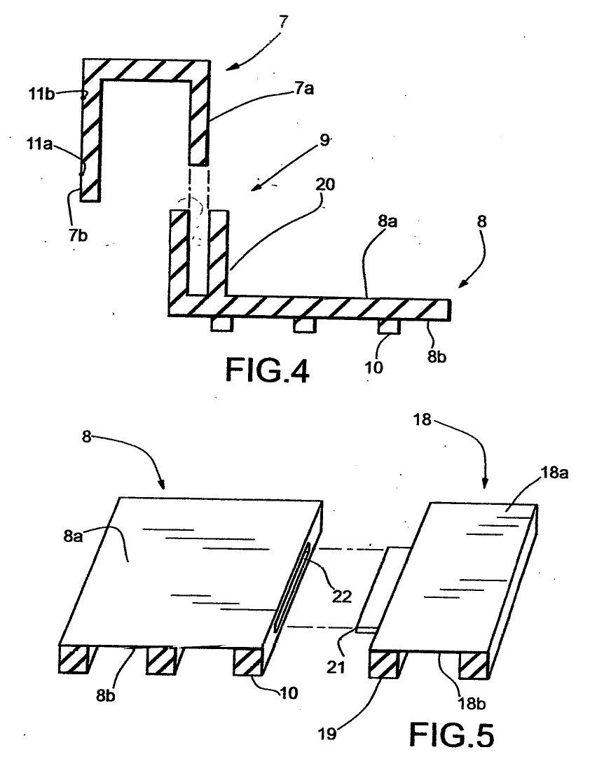

FIG. 4 is a sectional view of the connection means 9 including the sill riser cover 7 having a first leg 7a and a second leg 7b. The first leg 7a is inserted into the groove 20 defined by a pair of walls extending upwardly from the upper surface 8a of the sill plate cover 8 and a second leg 7b positioned on the “room side” of the sill riser 4. For example, once the carpet and carpet pad were installed, the sill riser cover 7 would be cut at score mark 11a. If wood flooring was laid then the sill riser cover 7 would be cut at score mark 11b.

FIG. 5 is a sectional view of the sill plate cover 8 having a plurality of channel members 10 extending from the lower surface 8b thereof. An additional segment 18 is provided with additional channel members 19 extending from the lower surface 18b and having a protuberance 21 capable of mating with opening 22 on the channel member 10. It is contemplated that this design could take on many different alternatives; for example, the opening 22 on channel member 10 could run the entire length thereof with the protuberance 21 running the entire length of the additional channel member 19. Openings 22 could be designed as a plurality of openings spaced along the channel member 10. Of course the protuberance 21 would be designed accordingly to mate the channel member 10 with the additional channel member 19. As another alternative, the protuberance 21 could extend from the channel member 10 with the openings 22 formed in the additional channel member 19.

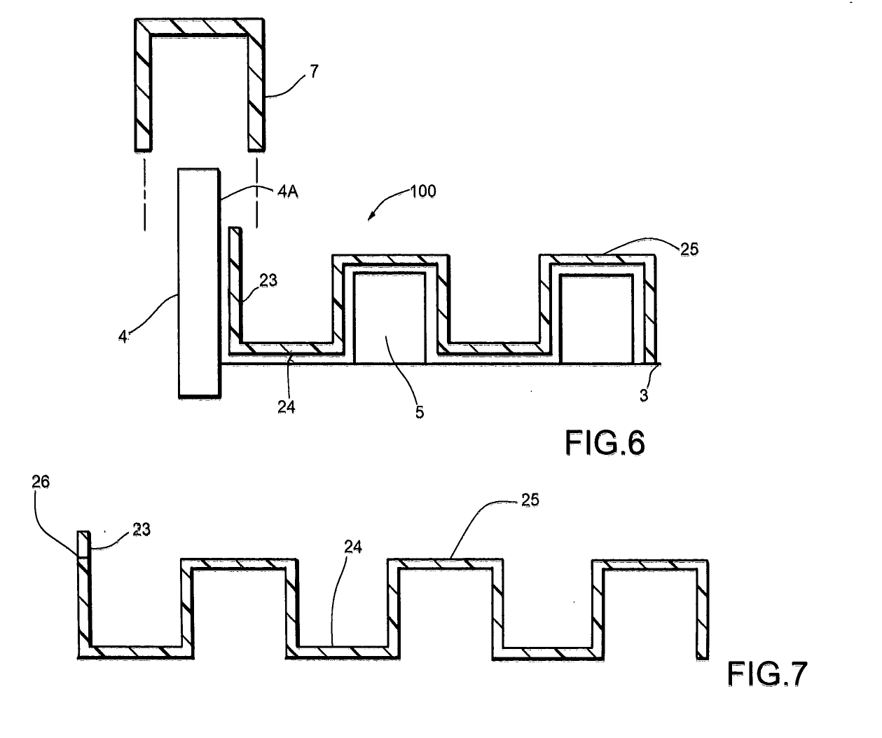

FIG. 6 is a sectional view of the protector unit 100 for a sill plate 3 and sill riser 4 and comprises a sill plate cover 8 having two roller tracks 5 and sill riser cover 7. The present invention contemplates that the sill plate cover 8 and the sill riser cover 7 are thermo formed as a unitary flexible unit made from Acetyl-Butyl-Styrene (ABS) or High Impact Polystyrene (HIPS) in four foot lengths or longer and one millimeter thick. It is contemplated that these sections could be placed end to end to extend protection along the length dimension of the sill plate 3. They could be glued together on site or a connection means could be provided. A tab 23 is positioned to be adjacent to the outside edge 4a of the sill riser 4, a web 24 is positioned between the tab 23 and the roller track covers 25, each roller track cover 25 are inverted u-shaped having legs extending down and connecting to each web 24. At the job site the Protect a Track is placed on the sill plate 3 wherein the roller track covers 25 are positioned over each roller track 5 each web 24 is positioned between the roller tracks 5 and the tab 23 abuts the outside edge 4a of the sill riser 4. Once in position the sill riser cover 7 is placed over the sill riser 4 and the tab 23 as shown to lock the sill plate cover 8 securely in place as a force fit.

FIG. 7 is a sectional view of the present invention showing the Protect A Track that can be used in a three track sliding door system. Upwardly extending tab 23 has a score line 26 to facilitate field trimming.

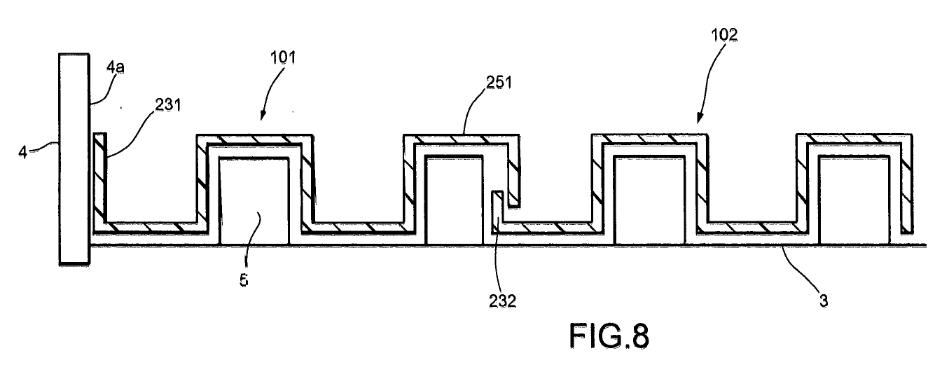

FIG. 8 is a sectional view of a sill plate 3 designed for up to four roller tracks 5. In this situation a first protector unit 101 is positioned adjacent to a second protector unit 102 along the width dimension of the sill plate 3 such that the tab 231 of the first protector unit 101 is adjacent to the outside edge 4a of the sill riser 4 and the tab 232 of the second protector unit 102 is positioned adjacent the roller track 5 covered by the roller track cover 251 of the first protector unit 101 and wherein the tab 232 is placed next to the side of the roller track 5 with the roller track cover 251 locking in place the tab 232 of the second protector unit 102 by a force fit. Sill riser cover 7 is placed over the sill riser 4 and tab 231 thereby creating a unitary flexible unit.

1: A protector unit adapted to protect a sliding door frame having a sill plate having a width and length dimension and a sill riser and wherein said sill plate has a plurality of roller tracks separated by a horizontal space and wherein the sill riser has a room side edge and an outside edge comprising: a sill plate cover including a upwardly extending tab adapted to be positioned next to the outside edge of the sill plate riser, a plurality of inverted u-shaped roller track covers and a plurality of horizontal web members formed as a rigid, flexible and unitary unit, each inverted u-shaped roller track cover includes a first and second leg which are connected to each horizontal web member and a sill riser cover formed as an inverted u-shaped locking member such that when positioned over the sill riser the sill riser cover locks said tab of the sill plate cover into place by a forced fit and wherein each inverted u-shaped track covers correspond to each roller track and wherein each horizontal web member corresponds to each horizontal space.

2: The protector wilt as set forth in claim 1, wherein said sill plate cover has two inverted u-shaped roller track covers and at least one horizontal web member and one upwardly extending tab and wherein said one upwardly extending tab has a score line to facilitate field trimming.

3: The protector unit as set forth in claim 1, wherein said sill plate cover has three inverted u-shaped roller track covers and at least two horizontal web members and one upwardly extending tab and wherein said one upwardly extending tab has a score line to facilitate field trimming.

4: The protector unit as set forth in claim 1, wherein said sill plate has four roller tracks separated by horizontal spaces and a first and second protector unit positioned next to each other along said width dimension and wherein the upwardly extending tab of said first protector unit is positioned next to the outside edge of said sill riser and the upwardly extending tab of the second protector unit is positioned under the roller track cover of the first protector unit.

5: The protector unit as set forth in claim 4, wherein the upwardly extending tab of said first and second protector units have score lines to facilitate field trimming.
